(19) United States
(12) Patent Application Publication
(10) Pub. No.: US 2005/0229130 A1
(43) Pub. Date: Oct. 13, 2005

(54) Method and apparatus for selective, incremental, reconfigurable and reusable semiconductor manufacturing resolution-enhancements

(75) Inventors: Shao-Po Wu, Portola Valley, CA (US); Xin Wang, Sunnyvale, CA (US); Hongbo Tang, San Jose, CA (US); Meg Hung, Saratoga, CA (US)

Correspondence Address: FENWICK & WEST LLP, SILICON VALLEY CENTER, 801 CALIFORNIA STREET, MOUNTAIN VIEW, CA, 94041, US

(73) Assignee: Aprio Technologies, Inc., Palo Alto, CA (US)

(21) Appl. No.: 10/820,260

(22) Filed: Apr. 7, 2004

(51) Int. Cl. G06F 17/50

(52) U.S. Cl. 716/8; 716/10

(57) ABSTRACT

An automated design for manufacturability platform for integrated physical verification and manufacturing enhancement operations. Given original layouts and one or more associated resolution-enhanced layouts, intermediate resolution-enhancement state layouts are reconstructed, and selective localized resolution-enhancement reconfigurations, modifications, and/or perturbations are introduced on any existing enhancements in order to improve manufacturability and yield.

### BACKGROUND

1. Field

The present invention relates to design, verification and manufacturing of integrated circuits, and in particular to the incremental and selective reconfiguration of resolution-enhancements on integrated circuit layouts.

2. Related Art

While conventional resolution-enhancement technologies (RET), such as optical proximity correction (OPC), are widely applied in advanced design-to-manufacturing processes in order to improve manufacturability and yield of circuit layouts, such enhancements are difficult to verify and verification results do not necessarily translate to systematic methods of correcting RET/OPC. Furthermore, RET/OPC cannot be applied incrementally or reconfigured selectively, due to proximity and hierarchical interactions of the enhancements. The result is the application of “one-shot” RET/OPC operations to an entire circuit layout, followed by a verification step, wherein a negative result of the verification step forces an adjustment of the RET/OPC settings and a reapplication of the full set of adjusted RET/OPC operations to the entire circuit layout. This approach is inefficient and time-consuming. The conventional approach presents a further disadvantage in that it prohibits the application of RET/OPC to standard cells and intellectual property (IP) cores in a way that allows such layouts to be reused as well as characterized early in the design flow.

Accordingly, a fundamentally new approach to RET/OPC is needed, allowing incremental, selective and locally reconfigurable applications of RET/OPC early in the design flow.

### SUMMARY

An automated system for incremental and selective application and reconfiguration of resolution-enhancements, such as optical proximity corrections (OPC), on integrated circuit (IC) layouts in order to provide enhancement, enhancement fix, reconfiguration and layout reuse capability. Starting from original layouts and one or more associated resolution-enhanced layouts, intermediate resolution-enhancement state layouts are reconstructed. Using a damping algorithm, selective localized resolution-enhancement reconfigurations, modifications, and/or perturbations are introduced on any existing layout enhancements in order to improve manufacturability and yield.

### BRIEF DESCRIPTION OF DRAWINGS

FIG. 1a is a flow diagram illustrating a method for creating and verifying circuit representations up to the point of tape-out, according to an embodiment of the present invention.

FIG. 1b is a flow diagram illustrating a method for processing a circuit layout after tape-out and in preparation for manufacturing, according to an embodiment of the present invention.

FIG. 2a shows the appearance of a layout portion defining five adjacent metal wires, wherein region 30 comprises densely packed wires and region 31 comprises only one isolated wire, according to an embodiment of the present invention.

FIG. 2b shows an example layout enhancement applied in order to reduce proximity effects of the silicon manufacturing process and thereby improve manufacturability and yield, according to an embodiment of the present invention.

FIG. 3 shows an example of a polygon representing a circuit layout element, according to an embodiment of the present invention.

FIG. 4a is a diagram illustrating a non-RET layout 50 and an RET version 51 of the same layout 50 superimposed.

FIG. 4b shows the non-RET layout 50 broken into a set of fragments 52 delimited by a set of vertices 53, wherein the placement of the vertices 53 (and hence the set of fragments 52) is generated by the intersection of the two layouts 50 and 51.

FIG. 4c shows an example of fragment attribute assignments after re-applying fragment rules, according to an embodiment of the present invention.

FIG. 5a is a flow diagram showing a method for computing an intermediate enhancement state layout, according to an embodiment of the present invention.

FIG. 5b is a flow diagram showing a method for incremental and reconfigurable resolution-enhancement, according to an embodiment of the present invention.

FIG. 5c is a flow diagram describing a method for locally re-converging an assembly of intermediate enhancement layouts, according to an embodiment of the present invention.

FIG. 6 is a diagram illustrating mirroring of a circuit block in order to simulate a set of neighbors, according to an embodiment of the present invention.

### DETAILED DESCRIPTION

The following serves as a glossary of terms as used herein:
Optical Proximity Correction (OPC)—Corrections applied to integrated circuit layout to pre-compensate proximity effects (i.e. on-silicon layout dimension/shape distortions caused by neighboring layout patterns within a certain proximity) introduced mainly by optical lithography in the manufacturing process.
Scattering-Bar (also known as Assist-Feature)—Correction features placed next to isolated edges on a mask in order to adjust the edge intensity at the isolated edge to match the edge intensity at a densely packed edge and thereby cause the feature having at least one isolated edge to have nearly the same width as features having densely packed edges.
Alternative Phase-Shifting—A technique for improving lithography resolution, phase-shifting shifts the phase of a first region of incident light waves approximately 180 degrees relative to a second, adjacent region of incident light waves. In this manner, the projected images from these two regions destructively interfere where their edges overlap, thereby improving feature delineation and allowing greater feature density on the IC.
Attenuated Phase-Shifting—Utilize attenuated (semi-transparent) phase-shifting mask regions to enhancement layout patterning on silicon.
Density Fill Pattern—Artificially introduced dummy layout patterns to adjust layout area pattern density to a desirable value.
Slotting—Artificially introduced dummy slots to existing layout patterns (e.g. wide metal interconnect) so as to adjust layout area pattern density to a desirable value.
Via-Array—Artificially introduced multiple contact vias to enhance manufacturability and yield.
Resolution-Enhancement Technologies (RET)—All available technology and methodology that may involve modifying circuit layout to achieve better layout patterning on silicon so as to enhance circuit manufacturability and yield.
Intermediate resolution-enhancement state (intermediate enhancement state)—A state of a layout in which it is prepared for and/or has undergone some resolution-enhancement operations. Layouts in such state comprise information for applying resolution-enhancements. Moreover, for layouts in such state, additional resolution-enhancements can be subsequently applied and the already-applied enhancements can be subsequently reconfigured.
Biasing—Sizing up or down specific circuit layout layers and/or patterns to accommodate for known biases of a manufacturing process.
Design rules—A set of geometric (for example, layer, width, space, area, density . . . etc.) rules that governs sufficient conditions for manufacturability of a given semiconductor manufacturing process.
Simulation-based verification result—Layout on-silicon patterning verification obtained via utilizing a lithographic process simulation engine.
Geometry-based verification result—Layout on-silicon patterning verification obtained via checking against a set of geometric rules.
Re-Converging—Reconfiguring a resolution-enhancement of one or more layout fragments in an intermediate resolution-enhancement state layout by determining an interacting neighborhood of the layout fragments, assigning damping factors to the layout fragments according to their proximity to a center of the reconfiguring area, and adjusting fragment enhancements according to their damping factors.

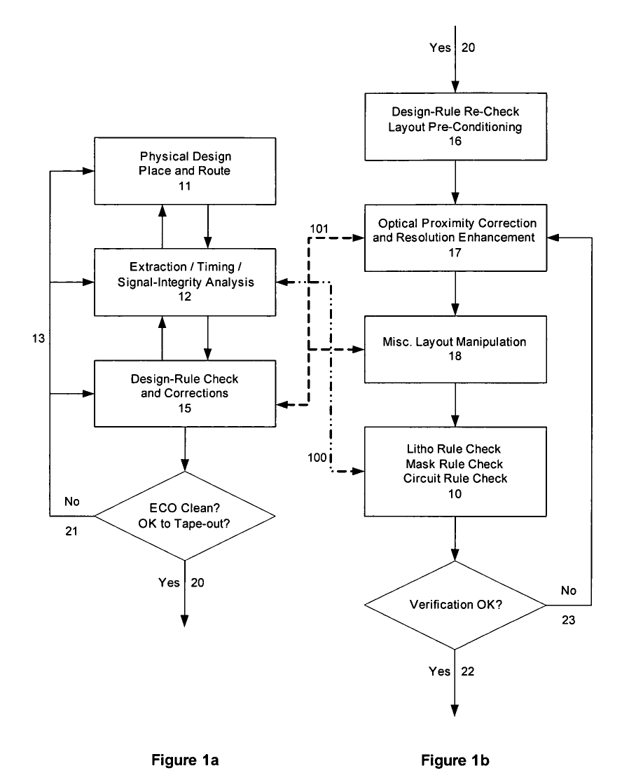

FIGS. 1a and 1b are flow diagrams illustrating a method for creating and verifying circuit representations up to the point of tape-out (FIG. 1a) and a method for processing a circuit layout after tape-out and in preparation for manufacturing (FIG. 1b), according to an embodiment of the present invention. The present invention uses intermediate enhancement state layouts (described below) to advantageously enable information exchange (shown by dotted arrows 100 and 101 between FIGS. 1a and 1b) between the design flow (FIG. 1a) and the manufacturing flow (FIG. 1b), thereby allowing the design flow to use information from the manufacturing flow, and vice versa. Such information exchange may also benefit from a software platform as described in U.S. utility patent application Ser. No. 10/643,799 incorporated herein by reference. The process comprises creating a circuit representation, verifying and predicting a performance of the circuit on silicon, checking design rules for manufacturability of the circuit, adding various layout and/or resolution-enhancements to facilitate the circuit manufacturing processes, and preparing final layout data for mask making. The process begins with the placement and the routing 11 of a circuit, wherein a set of complex circuit representations are assembled. Next, the process performs various verification 12 operations to attempt to predict circuit performance on silicon and to identify a set of one or more critical paths where circuit performance requirements may be in jeopardy, wherein this step may use information obtained from the rules check step 10 (FIG. 1b) of the manufacturing flow. The next step in the process is to check 15 the layout against a set of pre-determined worst-case geometric rules (design rules) provided by the manufacturers to ensure manufacturability of the design, and this step may use information generated by the resolution-enhancement step 10 (FIG. 1b) or information generated by the layout manipulation step 18 (FIG. 1b) of the manufacturing flow. Once the physical verifications are passed 20, the layout is taped-out from the design facility to the manufacturing facility. Note that the bi-directional arrows in-between steps 11, 12 and 15, and the loop 13 provide mechanisms for designers to incrementally build up their designs and fine-tune, correct and accommodate necessary changes without the need to sequentially repeat these steps on the entire design multiple times. The first step in the manufacturing data preparation process (FIG. 1b) comprises a design-rule check 16, and optionally one or more manufacturing-specific layout pre-conditioning processes, such as separating the layers and biasing specific layers. The next two steps (steps 17 and 18) in the process add one or more resolution-enhancement features to the layout (described below), wherein these steps may use information generated by the design rule check step 15 (FIG. 1a) of the design flow. The layout is then verified 10 against a set of predefined process-simulation-based and/or geometry-based rules for manufacturability in preparation for mask making, wherein this verification step 10 of the manufacturing flow may use information generated by the verification step 12 (FIG. 1a) of the design flow. Note that the above operations are applied sequentially to the entire layout. In case that the result of step 10 is not passed, steps 17, 18 and 10 are repeated on the entire layout (via loop 19) to refine and/or correct the resolution-enhancement.

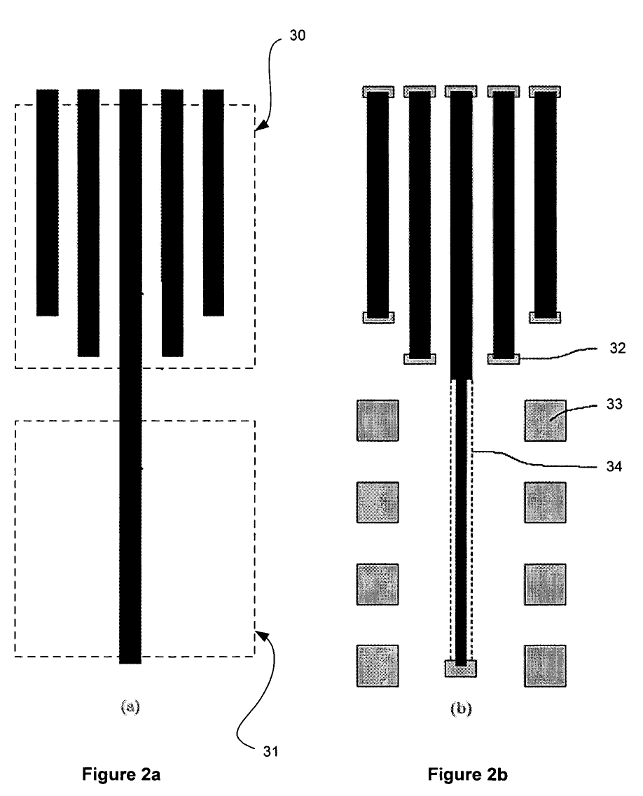

FIGS. 2a and 2b illustrate an example of manufacturing-specific layout enhancements applied to metal interconnections. FIG. 2a shows the appearance of a layout portion defining five adjacent metal wires, wherein region 30 comprises densely packed wires and region 31 comprises only one isolated wire, according to an embodiment of the present invention. FIG. 2b shows an example layout enhancement applied in order to reduce proximity effects of the silicon manufacturing process and thereby improve manufacturability and yield, according to an embodiment of the present invention. Region 32 shows “additive” optical proximity corrections, region 33 shows “dummy” fill patterns used to equalize the area pattern density, and region 34 shows “subtractive” optical proximity correction. While it is understood that such enhancement features are to be applied accurately with respect to the manufacturing process within which they are intended to be used, it is non-trivial to (a) verify whether the enhancements are properly applied or not (step 10 in FIG. 1), and (b) correct any enhancements that fail any verification steps. For illustrative simplicity, in what follows OPC is used as the enhancement example in order to illustrate the present invention without loss of generality. The same principles can be applied to other types of resolution-enhancements, including but not limited to scattering-bar/assist-feature, density-fill pattern, slotting, via-array, alternate phase-shifting and attenuated phase-shifting.

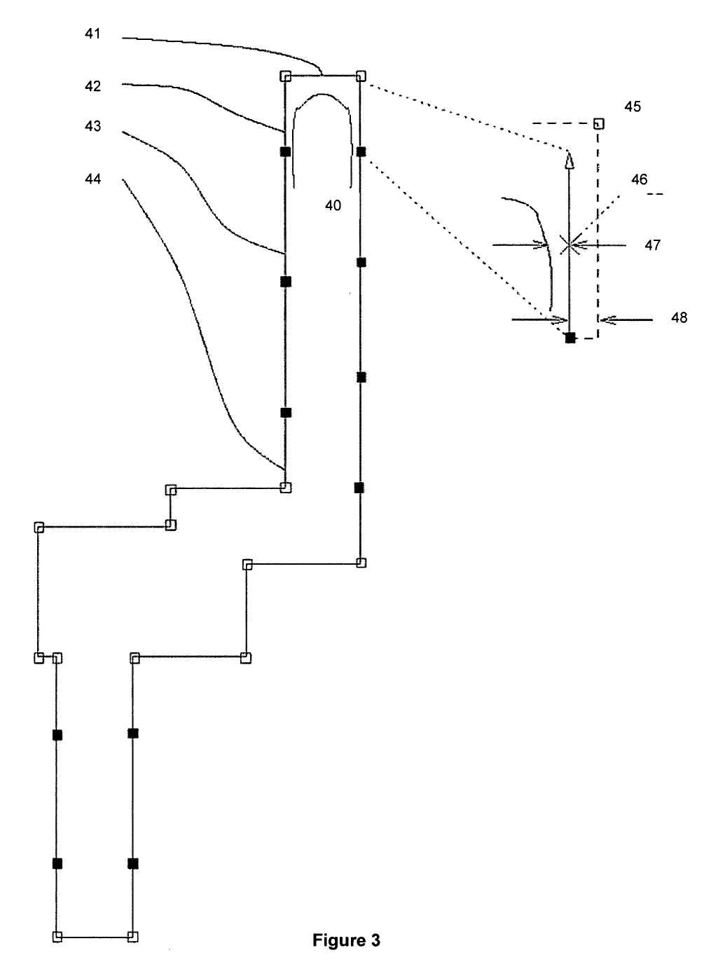

FIG. 3 shows an example of a polygon representing a circuit layout element, according to an embodiment of the present invention. The polygon edges are sub-divided into fragments (for example fragments 41, 42, 43 and 44) so as to apply OPC corrections at one or more individual fragments. Fragments are the fundamental data object used in OPC operations (and in other similar types of optical enhancements). In one embodiment, a fragment comprises the following attributes (illustrated in FIG. 3):
Fragment type—An attribute that identifies the shape (line-edges, corners, line-ends . . . etc.) association of a given fragment. This attribute further indicates a desirable correction strategy (such as correction tolerance and minimum/maximum correction amounts) associated with the assigned shape. Commonly used fragment types are edges 43, corners 44, line-end ends 41 and line-end corners 42. Other fragment types include (but are not limited to) inner-corners, outer-corners, anti-serifs and turn-ends.
Evaluation anchor 46—The location on a fragment where we apply simulation to evaluate offset (see below).
Offset 47—The distance between the evaluation anchor and the simulated silicon pattern 40. This is the amount of proximity error that we would like to correct using OPC.
Bias 48—The amount of correction to be applied. Note that the bias value is not converted into a bias/OPC vertex (see below) unless the OPC process is finished. This provides the capability of reconfiguring OPC corrections (“soft” corrections) at any given time until a joining operation is performed to create a final OPC corrected polygon (to “harden” the corrections).
Joined OPC vertex 45—Once the OPC iterations are completed, we join the biases from neighboring fragments to form joined OPC vertices. These vertices form the final OPC corrected polygon.
Width/space info—A DRC engine can be invoked either before or after fragmentation in order to record neighboring fragment width/space numbers. This information can be used to identify specific types of fragments, or to properly constrain a bias amount to prevent potential design rule violations.

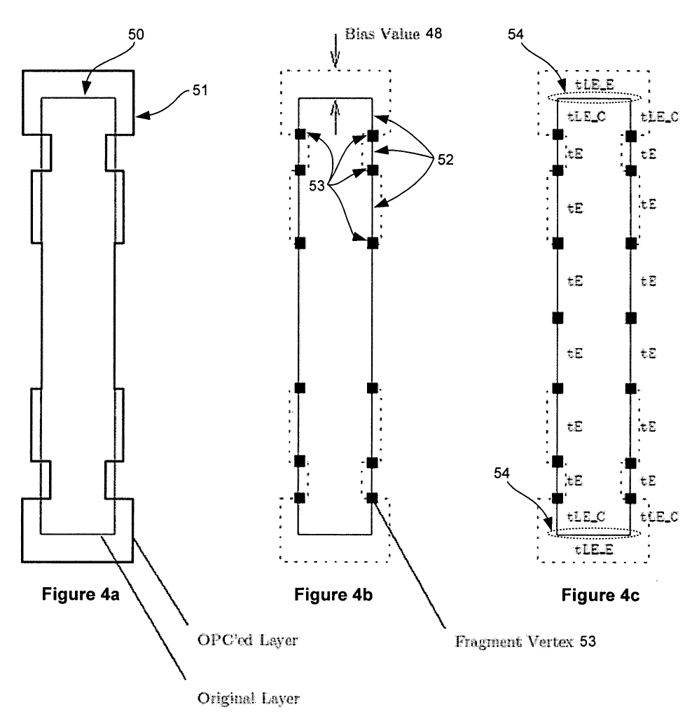

FIG. 4a, 4b and 4c illustrate an example for computing an intermediate enhancement state layout. FIG. 4a is a diagram illustrating a non-RET layout 50 and an RET version 51 of the same layout 50 superimposed. FIG. 4b shows the non-RET layout 50 broken into a set of fragments 52 delimited by a set of vertices 53, wherein the placement of the vertices 53 (and hence the set of fragments 52) is generated by the intersection of the two layouts 50 and 51. The dotted regions around a fragment 52 represent the bias 48 associated with the fragment, as given by the particular RET version 51 of the non-RET layout 50. FIG. 4c shows that the resulting layout from FIG. 4b can be further processed such that the fragments are associated with fragment types based on a set of predefined shape rules. For example, the two ends 54 of the rectangle are assigned with type “line-end end” (tLE_E) as shown; the fragments along the two sides of the rectangle are assigned with type “line-edge” (tE) as shown.

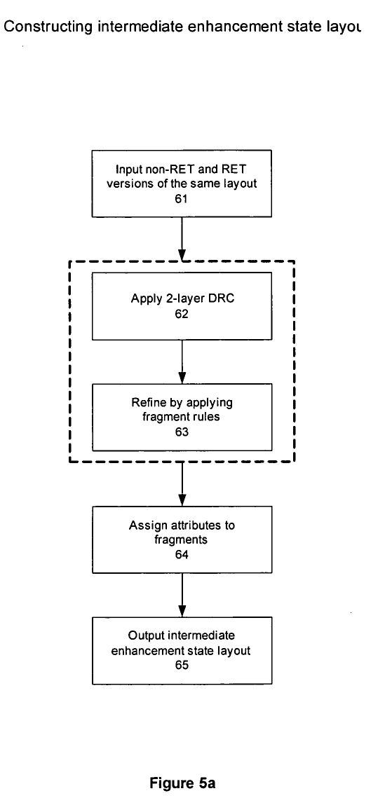

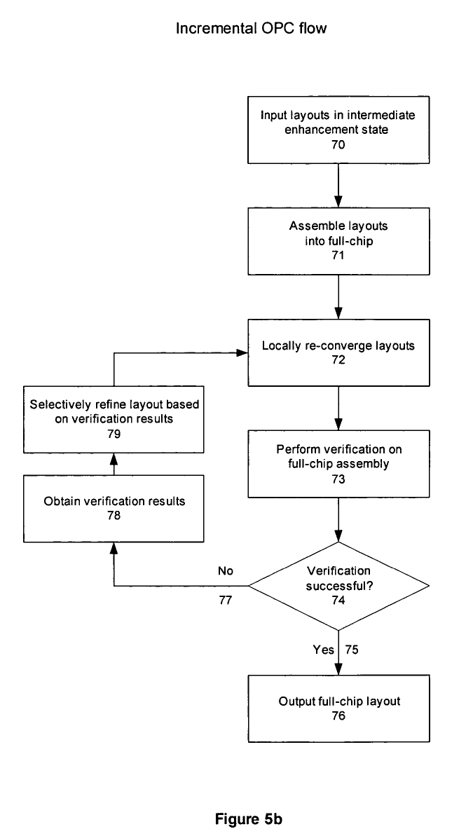

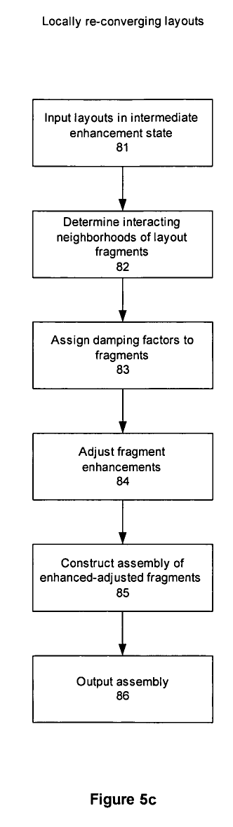

FIG. 5a is a flow diagram showing a method for computing an intermediate enhancement state layout, according to an embodiment of the present invention. Start 61 with two layouts, the first comprising a non-RET layout of a circuit and the second comprising an RET layout of the same circuit. Fragment the non-RET layout by first applying 62 a 2-layer geometry-operation algorithm on the pair of layouts to obtain an initial fragmented version of the non-RET layout, and then refining 63 the initial fragmented version of the non-RET layout using a set of fragment rules. Assign 64 a set of fragment attributes to the fragments of the resulting fragmented layout and output 65 the result as an intermediate enhancement state layout. A data structure is used for representing a layout fragment or an intermediate enhancement state layout, wherein the data structure comprises fragment locations, fragment attributes, fragment types and/or fragment biases. Optionally, a data structure is used for representing a plurality of attributes (fragment locations, fragment types and/or fragment biases) describing intermediate enhancement state layout fragments, wherein some of the attributes are grouped according to a mutual proximity of the corresponding fragments.

Once one or more intermediate enhancement state layouts are generated, they can be assembled into a full-chip in order to undergo incremental resolution-enhancement as follows. FIG. 5b is a flow diagram showing a method for incremental and reconfigurable resolution-enhancement, according to an embodiment of the present invention. Start 70 with one or more intermediate enhancement state layouts and assemble 71 the layouts into a full-chip configuration. Locally re-converge 72 the intermediate enhancement layouts individually (details of local re-converging are described below and in FIG. 5c), and perform 73 verification on the full-chip assembly. If the full-chip layout passes 75 the verification step 74, output 76 the full-chip layout. If the full-chip layout does not pass 77 the verification step 74, obtain 78 verification results representing feedback from the verification step 74, selectively refine 79 the full-chip layout based on the obtained verification results and repeat from step 73 of locally re-converging the full-chip layout, until the resulting full-chip layout passes the verification step 74. Examples of such obtained verification results comprise (a) simulation-based results, for example indicating that a resolution-enhanced (e.g. OPC corrected) full-chip assembly is not suited (e.g. is out of manufacturing-tolerance) for a particular manufacturing process, (b) geometry-based results, for example indicating a violation of minimum spacing rules, and/or other verification rules.

Note that the flow of FIG. 5b naturally accommodates any modifications made to a layout as a result of an engineering change order (ECO). An intermediate enhancement state layout in such a full-chip layout assembly may undergo one or more modifications as a result of an ECO, wherein a modification comprises a redesign of one or more blocks within the layout. The modified layout is then converted to an intermediate enhancement state layout and re-inserted into the full-chip assembly of step 71, after which the flow of FIG. 5b is resumed from the local re-converging step 72 to eventually arrive at a resolution-enhanced (e.g. OPC corrected) full-chip assembly which passes the verification step 74.

It is an advantageous aspect of the present invention that the incremental and reconfigurable resolution-enhancement method allows for (a) localized and selective perturbations and/or refinements on manufacturing enhancements, based upon verification results, (b) localized and selective resolution-enhancement reconfigurations on IP blocks, cores and/or libraries, based upon manufacturing process settings, as well as (c) localized resolution-enhancement reconfigurations on already resolution-enhanced and assembled IP blocks, cores and/or libraries to accommodate for any necessary enhancement changes due to proximity interactions.

FIG. 5c is a flow diagram describing a method for locally re-converging an assembly of intermediate enhancement layouts, according to an embodiment of the present invention. Start 81 with one or more intermediate enhancement state layouts (which can be obtained using the method described using FIG. 4a, 4b and 4c). Determine 82 interacting neighborhoods of layout fragments, wherein the layout fragments are to be reconfigured. Preferably the determining step 82 is done by extending from the said fragments a certain halo, wherein the halo is according to the proximity range of the manufacturing processes. Assign 83 damping factors to the layout fragments within the interacting neighborhoods, wherein fragments that are closest to the center of the reconfiguring area receive the most damping and fragments that are farthest to the center of the reconfiguring area receive the least damping. This damping strategy allows a smooth local re-convergence of OPC corrections. Then, adjust 84 fragment enhancements according to the assigned fragment damping factors. Construct 85 an assembly of the enhancement-adjusted fragments, and output 86 the assembly.

It is an advantageous aspect of the present invention that the processing involved in resolution-enhancing a plurality of blocks in a layout can be combined as follows. Select a plurality of blocks in a layout and generate (a) a new “common-block” which comprises layout elements that are common to the selected blocks, as well as (b) a plurality of difference-sets representing differences between the individual selected blocks and the common-block. Perform resolution-enhancement on the common-block, combine the resolution-enhanced common-block with the difference-sets to obtain a set of resolution-enhanced counterparts to the originally selected blocks, and replace the originally selected block with their resolution-enhanced counterparts. Finally, re-converge the inserted resolution-enhanced counterparts in the layout.

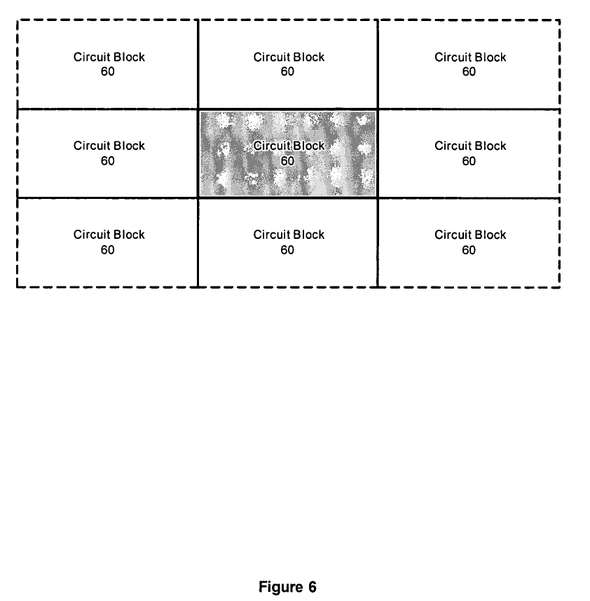

It is a further advantageous aspect of the present invention that mirroring can be used to simulate a set of neighbors when performing resolution-enhancement on an individual block, as shown in FIG. 6. When performing resolution-enhancement on a block 60, mirroring one or more copies of the block 60 around the block 60 simulates a set of neighbors, affecting the outcome of the resolution-enhancement process on block 60. The block 60 can then be re-inserted into a layout or assembled with other blocks and re-converged.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

1. A method for generating a layout, comprising the steps of:
applying a 2-layer geometry-operation algorithm to a first layout and a second layout, wherein the first layout is not resolution-enhanced and the second layout is a resolution-enhanced version of the first layout; and
generating a third layout, wherein the third layout comprises one or more fragments, the one or more fragments comprising one or more biases, the one or more biases according to one or more amounts of resolution-enhancement of the second layout as compared to the first layout.

2. A data structure for representing an intermediate resolution-enhancement state layout fragment, the data structure indicating a location of the fragment and a bias of the fragment.

3. The data structure of claim 2, further indicating a type of the fragment.

4. A method for performing resolution-enhancement, comprising the steps of:
assembling a plurality of layouts into a full-chip assembly, a first layout of the plurality of layouts comprising an intermediate resolution-enhancement state layout; and
verifying the full-chip assembly.

5. The method of claim 4, further comprising generating a result of the verifying step, the result comprising a simulation-based verification result or a geometry-based verification result, the result for serving as input into a damping algorithm, the damping algorithm for re-converging a resolution-enhancement of the first layout.

6. The method of claim 4, further comprising the steps of:
selecting a first layout fragment of the first layout; and
adjusting a resolution-enhancement of the first layout fragment, the adjusting step according to a result of the verifying step.

7. The method of claim 6, wherein the result of the verifying step comprises a simulation-based verification result or a geometry-based verification result.

8. A method for performing resolution-enhancement, comprising the steps of:
modifying a first layout in a full-chip layout assembly to produce a second modified layout;
converting the second modified layout to a third intermediate resolution-enhancement state layout;
inserting the third intermediate resolution-enhancement state layout into the full-chip assembly for verification;
wherein the modifying step comprises a re-design of an IP block, IP core or library within the first layout according to an engineering change order.

9. The method of claim 8, further comprising the step of verifying the full-chip assembly.

10. A method for locally perturbing layout resolution-enhancement, comprising the steps of:
determining an interacting neighborhood of a layout fragment, the layout fragment comprising a fragment resolution-enhancement, the interacting neighborhood comprising a halo extended from the layout fragment according to a proximity range of a manufacturing process;
assigning a damping factor to the layout fragment, the damping factor according to a proximity of the layout fragment to a center of the interacting neighborhood; and
adjusting the fragment resolution-enhancement according to the damping factor.

11. An engineering workstation, comprising:
a processor; and
a memory unit;
wherein the memory unit comprises instructions for (a) assembling a plurality of layouts into a full-chip assembly, a first layout of the plurality of layouts comprising an intermediate resolution-enhancement state layout, and (b) verifying the full-chip assembly.

12. A data structure for representing a plurality of attributes, the plurality of attributes describing a plurality of intermediate resolution-enhancement state layout fragments, the plurality of attributes comprising one or more fragment locations, one or more fragment types and one or more fragment biases, wherein a first one or more attributes of the plurality of attributes are grouped according to a proximity of a first one or more fragments of the plurality of fragments.

13. A method for performing resolution-enhancement, comprising the steps of:
selecting a first plurality of layout blocks in a layout;
generating (a) a first block comprising a set of layout elements common to the first plurality of layout blocks, and (b) a plurality of difference-sets representing differences between (1) layout blocks in the first plurality of layout blocks and (2) the first block; and
performing resolution-enhancement on the first block to obtain a second resolution-enhanced block;
wherein the first and second blocks are in intermediate resolution-enhancement state.

14. The method of claim 13, further comprising the steps of:
combining the plurality of difference-sets with the second resolution-enhanced block to obtain a second plurality of resolution-enhanced blocks; and
inserting the second plurality of resolution-enhanced blocks into the layout.

15. The method of claim 14, further comprising the step of re-converging one or more boundaries of the second plurality of resolution-enhanced blocks, wherein the re-converging step proceeds according to a set of neighbors of the second plurality of resolution-enhanced blocks.

16. A method for performing resolution-enhancement, comprising the steps of:
performing a first resolution-enhancement on a layout;
modifying a first block of the layout, wherein the first block is in intermediate resolution-enhancement state;
performing a second resolution-enhancement on the first modified block; and
re-converging a resolution-enhancement of the first modified block according to a damping algorithm and according to a set of neighbors of the first modified block.

17. The method of claim 16, further comprising the step of verifying the layout after the re-converging step.

18. The method of claim 16, wherein the performing a second resolution-enhancement step comprises mirroring the first modified block to simulate a set of neighbors around the first modified block.

19. A method for performing resolution-enhancement, comprising the steps of:
performing a first resolution-enhancement on a first circuit block and a second resolution-enhancement on a second circuit block;
assembling the first and second resolution-enhanced circuit blocks to obtain a third aggregate circuit block; and
re-converging a resolution-enhancement of the third aggregate circuit block according to a damping algorithm;
wherein the first and second circuit blocks and the third aggregate circuit block are in intermediate resolution-enhancement state.

20. The method of claim 19, wherein the performing step comprises mirroring the first circuit block to simulate a set of neighbors around the first circuit block.

21. A method for performing resolution-enhancement, comprising the steps of:
assembling a plurality of resolution-enhanced layouts to obtain a first aggregate layout;
verifying the first aggregate layout to obtain a verification result;
modifying a first circuit block of the plurality of resolution-enhanced layouts according to the verification result to obtain a second modified aggregate layout, wherein the first circuit block is in intermediate resolution-enhancement state; and
re-converging a resolution-enhancement of the first circuit block according to a damping algorithm and according to a set of neighbors of the first circuit block.

22. The method of claim 21, further comprising the step of re-verifying the second aggregate layout.

23. A method for performing resolution-enhancement, comprising the steps of:
obtaining (a) a layout in intermediate resolution-enhancement state, the layout comprising a resolution-enhancement according to a first set of resolution-enhancement parameters, and (b) a second set of resolution-enhancement parameters;
re-converging a resolution-enhancement of the layout according to the second set of resolution-enhancement parameters and according to a damping algorithm.
